(19) United States
(12) Patent Application Publication
(10) Pub. No.: US 2009/0064040 A1
(43) Pub. Date: Mar. 5, 2009

(54) Dynamic Multi-Lingual Information Retrieval System for XML-Compliant Data

(75) Inventors: Joseph Wolf, Alexandria, VA (US); Nathan Summers, Alexandria, VA (US); Michaela Blondell, Potomac, MD (US)

Correspondence Address: BUCHANAN, INGERSOLL & ROONEY PC, POST OFFICE BOX 1404, ALEXANDRIA, VA, 22313-1404, US

(73) Assignee: COMPSCI RESOURCES, LLC, Alexandria, VA (US)

(21) Appl. No.: 12/041,961

(22) Filed: Mar. 4, 2008

Related U.S. Application Data
(63) Continuation-in-part of application No. 11/848,007, filed on Aug. 30, 2007.

(51) Int. Cl. G06F 3/048; G06F 7/10; G06F 17/30

(52) U.S. Cl. 715/810; 707/3; 707/E17.014

(57) ABSTRACT

Data that is in a tagged format, such as XML, is dynamically accessed on demand, without the requirement for pre-parsing documents containing the data and storing it in a database. A dynamic processor discovers and processes taxonomy documents pertinent to a data request by traversing linked relationships between documents. For taxonomies that contain data in multiple languages, the processor dynamically generates and renders a menu based upon the languages contained in the taxonomy, to enable a user to select any one of the languages for display of the data.

### CROSS REFERENCE TO RELATED APPLICATION

This is a continuation-in-part of U.S. patent application Ser. No. 11/848,007, filed Aug. 30, 2007, the disclosure of which is incorporated herein by reference.

### FIELD OF THE INVENTION

The present invention is directed to the analysis and viewing of information contained in documents that conform to the eXtensible Markup Language (XML) standard. In one embodiment, the invention can be applied to the retrieval and viewing of information contained in an extension of XML that is directed to the communication of business and financial data, known as the eXtensible Business Reporting Language (XBRL).

### BACKGROUND OF THE INVENTION

XML and various extensions thereof, such as XBRL, are becoming widely accepted as platforms for documents that are exchanged within groups. By conforming to the XML, standard, a document is structured in a manner that enables the information therein to be readily identified and displayed in a desired format for viewing purposes. The XBRL standard provides a good example of this functionality in the context of business and financial data. The structure of the data is defined by metadata that is described in Taxonomies. The Taxonomies capture the definition of individual elements of financial data, as well as the relationships between them. Within a document, these elements are identified by tags. The extensible nature of the language permits users to define custom Taxonomies, allowing for potentially infinite kinds of metadata.

Significant efforts are currently underway to adopt XBRL as a replacement for paper-based financial data collection, and various electronic mechanisms for financial data reporting. In the United States, for example, the Federal Deposit Insurance Corporation (FDIC) has instituted a project in which banks and similar types of financial institutions employ a form-based template to submit data in an XBRL format. The Securities and Exchange Commission (SEC) also has a project for the disclosure of company financial performance information, utilizing XBRL. This information can then be downloaded online, by authorized entities. Other users of XBRL-formatted information include companies that disseminate financial news. The XBRL format enables the various companies to distribute the financial information on a common platform.

It can be appreciated that, as the XBRL format is adopted for these types of uses, large collections of business and financial performance information in this format will be amassed. There is a growing need for an efficient mechanism to process and retrieve stored information from such a large collection.

In the past, the typical approach for information retrieval within a large repository of documents is to pre-parse each document in its entirety, and store the parsed information in another storage medium, such as a relational database. The database, rather than the documents themselves, then functions as the source of information that is searched to obtain data responsive to a request. Such an approach significantly increases storage requirements, since each item of information is stored twice, namely in the original document and in the parsed form. In addition, the information is not immediately available as soon as the document is loaded into the repository. Rather, the need to pre-process the document, to extract each item of information and store it in the database, results in a delay before the information contained in the document can be retrieved in response to a query.

Furthermore, since the information is stored in a database for retrieval, it is not readily adaptable to changes in the source documents or taxonomies. For example, if a new extension is created for the XBRL standard, the schema of the database needs to be redesigned to accommodate the extension. Until that is completed and the data is reloaded, queries cannot be based upon the extended features of the standard.

### SUMMARY OF THE INVENTION

In accordance with the invention disclosed herein, data that is present in a tagged format, such as XML data and XBRL data, can be dynamically accessed on demand. The data is obtained directly from the original document, thereby avoiding the need to pre-parse entire documents before the information can be retrieved. The manner in which this functionality is achieved is explained hereinafter with reference to exemplary embodiments illustrated in the accompanying drawings. It should be appreciated that, while specific examples are described with respect to the retrieval of information in XBRL-formatted documents, the concepts described herein are not limited to that particular application. Rather, they can be employed in the context of any type of data that conforms to the XML specification and any of its extensions.

### BRIEF DESCRIPTION OF THE DRAWINGS

FIG. 1 is a schematic diagram of the architecture of a system for accessing XBRL-formatted documents;

FIG. 2 is a schematic diagram illustrating the components of the dynamic processor;

FIGS. 3A-3E illustrate examples of the display of results returned from a query;

FIG. 4 illustrates presentation of data in a graph form;

FIG. 5 is an illustration of a user interface in which financial data can be viewed in a dimensional manner;

FIG. 6 is a representation of an XBRL label linkbase;

FIGS. 7A and 7B illustrate examples of data presented in two different languages; and

FIG. 8 is a schematic diagram of and exemplary architecture for a dynamic form generator;

### DETAILED DESCRIPTION

To facilitate an understanding of the concepts underlying the present invention, they are described hereinafter with reference to their implementation in the context of accessing information contained in XBRL-formatted documents. It will be appreciated, however, that this implementation is but one example of the practical applications of the invention. More generally, the invention is applicable to the retrieval of information that is presented in a format containing metadata that identifies each element of information. In particular, the invention is applicable to collections of XML-formatted documents, as well as each of the specific implementations of XML, such as XBRL. The following discussion should therefore be viewed as illustrative, without limiting the scope of the invention.

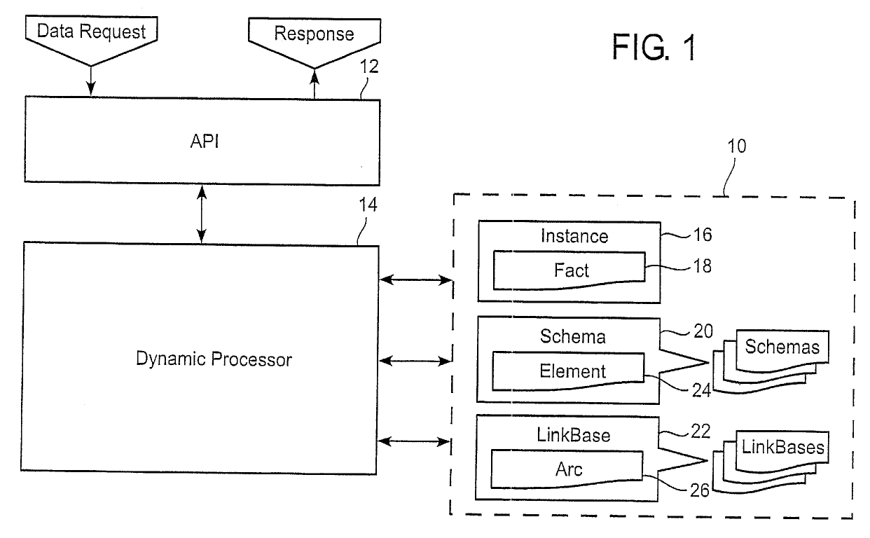

FIG. 1 illustrates the basic architecture of a system for access to XBRL documents, which implements the present invention. The fundamental components of the system comprise a repository 10 containing the XBRL documents, an application programming interface (API) 12 via which a user enters requests for information contained in those documents, and receives responses to the requests, for example by means of a browser, and a dynamic processor 14 that is responsive to a request received via the API, to retrieve information from the documents, and return it via the API 12.

XBRL is comprised of two fundamental components, namely an instance document 16, which contains business and financial facts, and a collection of Taxomomies, which define metadata about these facts. Each business fact 18 comprises a single value. In addition to facts, an instance document might contain contexts, which define the entity to which the fact applies, the period of time to which it pertains, and/or whether the fact is actual, projected, budgeted, etc. The instance document might also contain units that define the unit of measurement for the numeric facts that are presented within the document, as well as footnotes providing additional information about the fact, and references to Taxonomies.

The Taxonomies comprise a collection of XML Schema documents 20 and XLink linkbase documents 22. A schema defines facts by means of elements 24. For example, an element might indicate what type of data a Fact contains, e.g., monetary, numeric, textual, etc.

A linkbase is a collection of links. A link contains locators, that provide arbitrary labels for elements, and arcs 26, which indicate that an element links to another element, by referencing the labels defined by the locators.

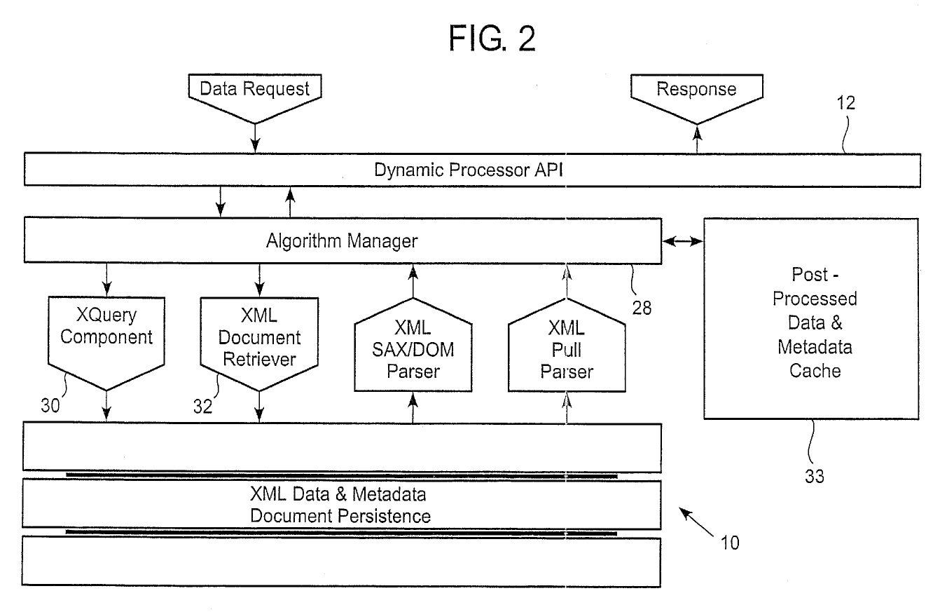

A more detailed view of the dynamic processor is illustrated in FIG. 2. A request for information is presented to the API 12, for example via a browser. This request, in the form of query, can be of a variety of different types. For example, one type of query might request a particular item of data for a number of different companies, e.g., annual revenue for all companies in the beverage industry. Another type of query may request all data for a given company of interest, or data over a particular time span, such as the ten-year revenue growth for a particular company. The API presents these requests to the dynamic processor 14, for example, in the form of a function call with parameters that identify the particular items of interest in the request.

The dynamic processor contains a number of pre-fabricated algorithms that are executed by an algorithm manager 28. Each algorithm is designed to retrieve information in response to a particular type of request. In essence, each algorithm implements a particular type or search strategy. For example, one algorithm can function to retrieve all items from a collection of documents, e.g., all data relating to a particular company. Another algorithm can function to retrieve the metadata associated with a particular fact.

The algorithms perform multi-step processes to first examine the metadata to obtain information about the semantics and structure of the instance documents, and then retrieve the appropriate metadata and data items from the XBRL documents that are responsive to the request. An illustrative example of the process performed by the algorithms is set forth hereinafter in the context of a request to provide the balance sheet of a designated entity.

1. In response to the request, the algorithm which corresponds to that type of request sends a query, for example using an XQuery language component 30, to a presentation linkbase in the Taxonomies, to locate presentation links that correspond to the sections of a balance sheet. It should be noted that, due to the extensible nature of XBRL, the Taxonomies that are applicable to a given filing could comprise multiple sets of Taxonomy documents. There could be a standard Taxonomy that is associated with the entity to which filings are presented. For instance, the SEC might establish a standard Taxonomy containing presentation links for balance sheet data. The documents for this standard Taxonomy might be stored in a known location within the repository. In addition, the entity submitting a filing could include custom Taxonomy documents with the instance documents that it submits. The custom Taxonomy constitutes an extension of the standard Taxonomy established by the SEC. In operation, the algorithm first goes to the standard Taxonomy to locate the appropriate presentation links.

2. Once the presentation links have been located, the algorithm then identifies concepts that are referenced by the presentation links, e.g. assets, current assets, non-current assets, etc.

3. Using these concepts and entities, and any other qualifiers such as specific date or date range, the algorithm employs an XMI document retriever 32 to locate corresponding items in the instance documents.

4. As a result of these steps, the algorithm discovers instance documents that contain the relevant data. In some cases, these documents may point to links in custom Taxonomies. In such a situation, these custom links are merged with the standard links, to obtain additional concepts.

5. Using the concepts, presentation links and preferred label attributes contained in the presentation links, the algorithm locates labels for the data in a label linkbase.

6. The algorithm returns the labels, presentation structure and data, e.g. numbers, to the API, to be formatted and presented to the user via the browser.

As an alternative to using XQuery, the dynamic processor can employ a different technology such as SAX (Simple API for XML) or XML Pull Parsing, or a combination of such technologies, to retrieve information from the XBRL instance documents and Taxonomy documents.

The dynamic processor preferably includes a cache 33 for storing information that has been retrieved and returned via the APT. This cached data can be used to reduce the time needed to respond to subsequent requests that seek some, or all, of the information that was returned in response to a previous request, and thereby eliminate duplicate processing. When a request is received, the algorithm manager 28 first checks the cache, to determine if a valid response to the request is present. If so, the response is retrieved from the cache, and immediately provided to the API in response to the request.

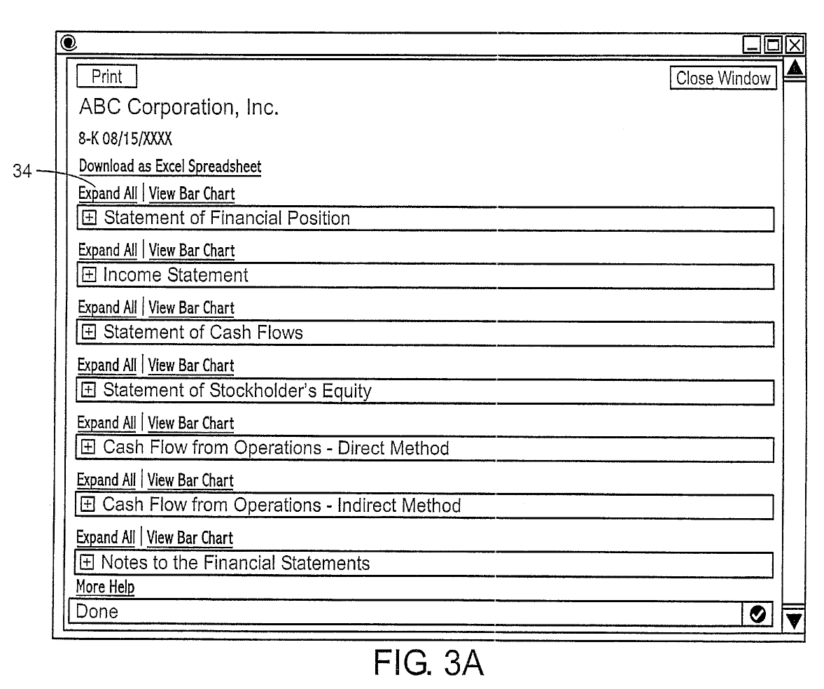

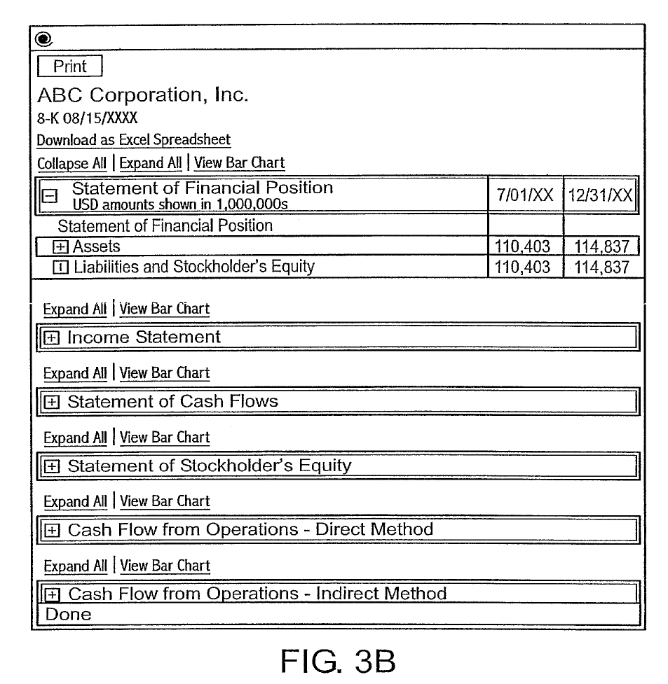

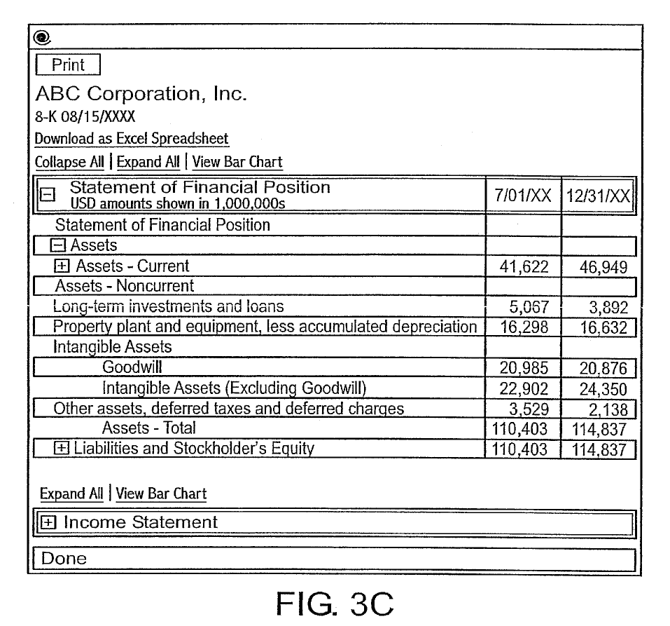

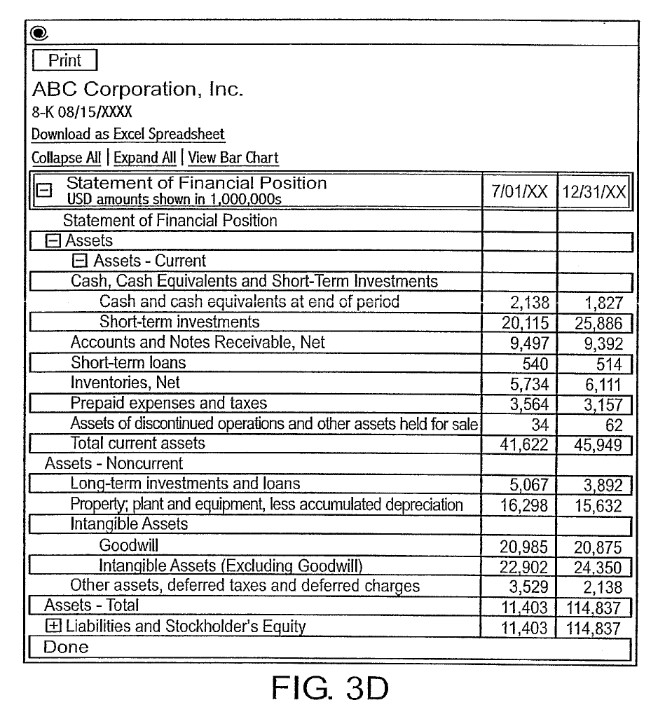

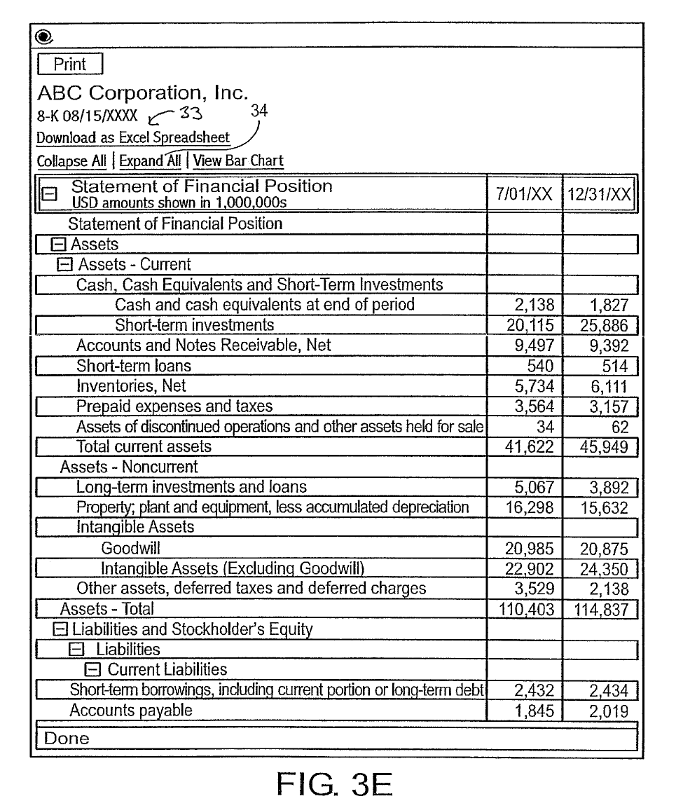

Examples of responses that might be displayed to a user via the browser interface are illustrated in FIGS. 3A-3E. In this particular example, the user has requested the latest filing of a 8-K Statement at the SEC for a particular company. FIG. 3A illustrates the initial screen that is presented to the user. This view presents a first-level listing of the sections of the statement. Each of these section headings are identified in the metadata for the filing, e.g. presentation links.

FIGS. 3B-3D illustrate views with progressively greater levels of detail in the first section “Statement of Financial Position”, under the heading for “Assets”, and numerical values corresponding to the various categories of assets. These numerical values, along with any dates to which they correspond and units of measurement, are retrieved from the instance documents themselves, whereas the displayed names for the asset categories are obtained from the metadata documents. Rather than select each successive level individually, the user can choose to expand and view all categories of data in the section at once, by selecting an appropriate button 34, as shown in FIG. 3E.

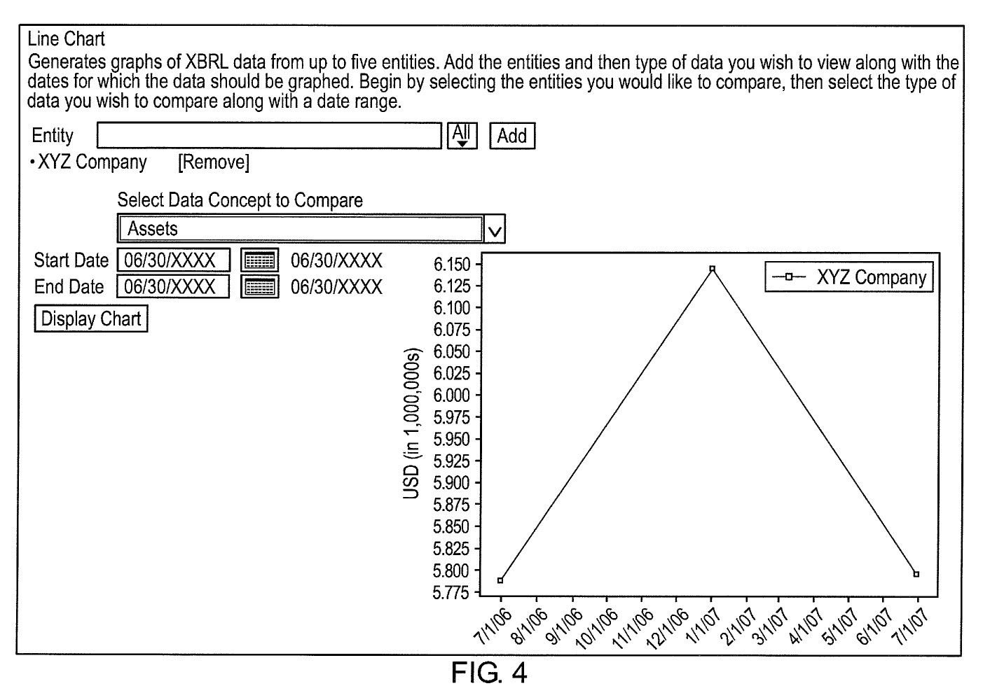

Since the data is presented in a tabular form, it can be easily reformatted and exported into a spreadsheet document. To this end, the browser window includes a command button, or link, 33, to enable the user to instruct the dynamic processor to perform such an operation. Within this capability, the data can also be presented in graphs, an example of which is depicted in FIG. 4. As such, the user can compare data for different companies, or different divisions within a company, over a given period of time.

In addition to retrieving data items that are contained in the instance documents and providing them in a view such as those shown in FIGS. 3A-3E, the algorithms in the dynamic processor also have the ability to calculate additional data that does not explicitly appear in the instance documents. For instance, in the example of FIGS. 3A-3E, the instance documents might contain items for each of the individual categories of assets, as shown in the view of FIG. 3D. However, they may not contain an item corresponding to the sum of all of the individual categories of assets, which is shown in FIG. 3B. In this case, the appropriate algorithm refers to the linkbase 22 to locate an equation which defines the items that make up the requested calculation. The algorithm then sends a query requesting each of those items, and sums them to obtain the desired total.

Since the dynamic processor dynamically reads the information in the XBRL documents in response to a request, rather than being hard-coded to process a particular Taxonomy, it is capable of uploading and processing any Taxonomy on demand, including both the base Taxonomy and any extensions. Thus, as new Taxonomies are developed, or new extensions are created for current Taxonomies, the dynamic processor is able to handle them immediately, rather that requiring an upgrade or redesign to accommodate new types of information.

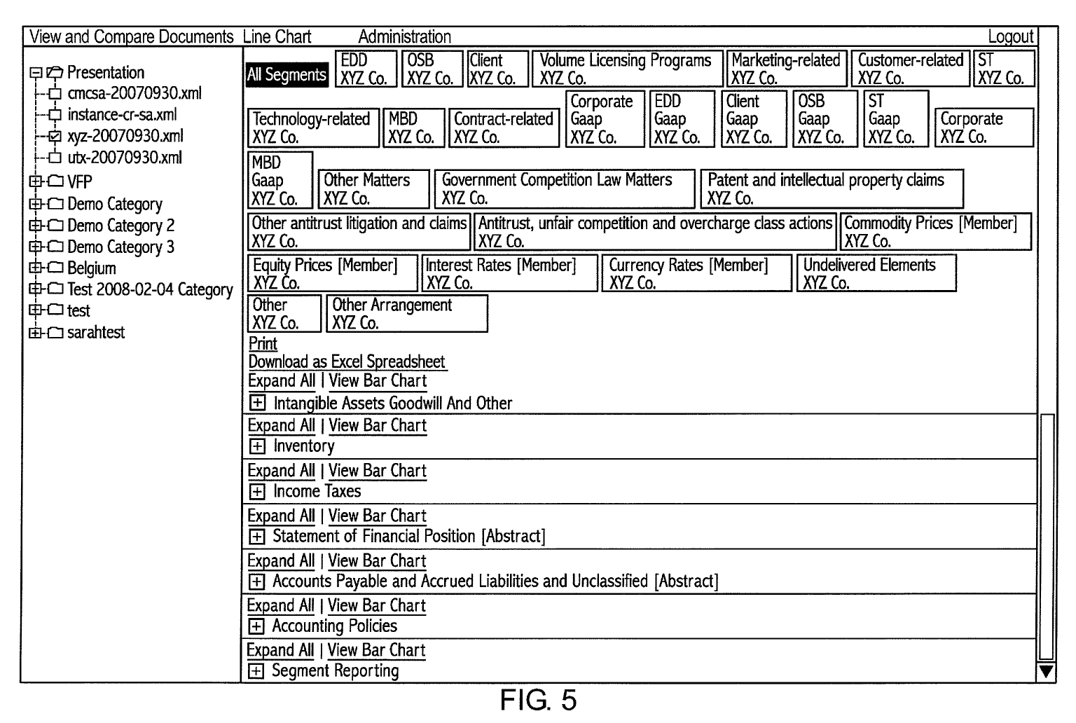

In this regard, a particular extension that has been developed for XBRL data is a specification known as dimensions. This specification enables the data to be further divided into desirable categories, for viewing and comparison purposes. For instance, a company structure might comprise a number of different segments, each of which has data allocated to it. When dimensions are incorporated into the Taxonomy for a company's financial documents, the dynamic processor enables the user to view the data that pertains to only one of the segments, or view the data of multiple segments in a side-by-side manner for comparison purposes. This is accomplished by reading the dimensions in the metadata of the documents. FIG. 5 illustrates one example of different segments for a company's financial data. Each segment has a corresponding tab on the user interface. In the illustrated example, the tab for “All Segments” is highlighted, indicating that the data for the entire company is displayed for each labeled category of information. By selecting any one of the segment-specific tabs, the displayed data can be confined to only that pertaining to the selected segment of the company's financial information.

It is possible that the labels for the data contained in XBRL documents can be presented in two or more different languages. For instance, some countries have more than one national language, and it may be desirable to view that data in any one of those languages. Likewise, a multi-national corporation may publish its data in the language of each of the countries where it has a presence. In such cases, the label linkbase in the taxonomy for those types of documents can contain multiple sets of labels, one for each language associated with the document. Thus, one set of labels may be in English, another corresponding set in French, etc.

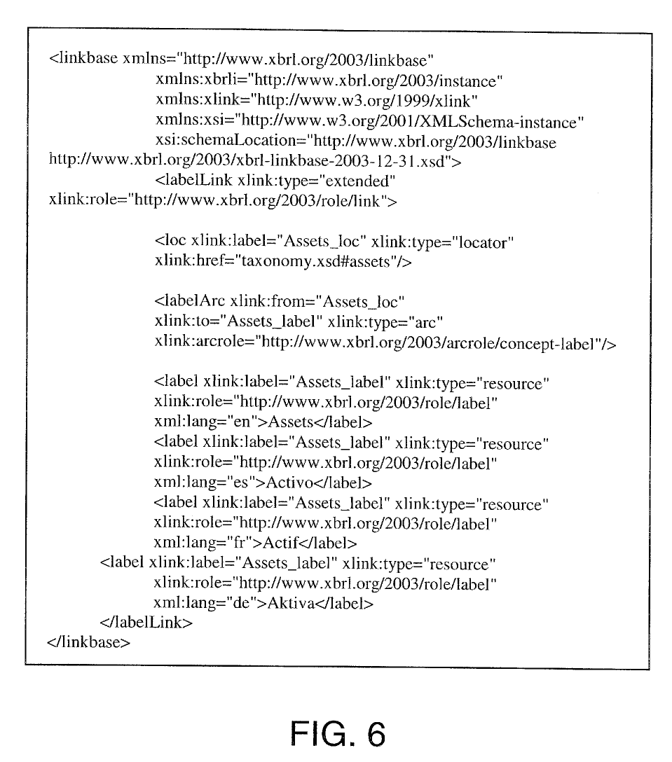

FIG. 6 illustrates an example of an XBRL label linkbase containing labels in multiple languages. The particular label represented in this linkbase, in English, is “Assets”. The first entry in the linkbase with the descriptor “xml:lang” corresponds to the English version of the label. This entry is followed by three other entries for the same label, which respectively pertain to the Spanish, French and German versions of the label.

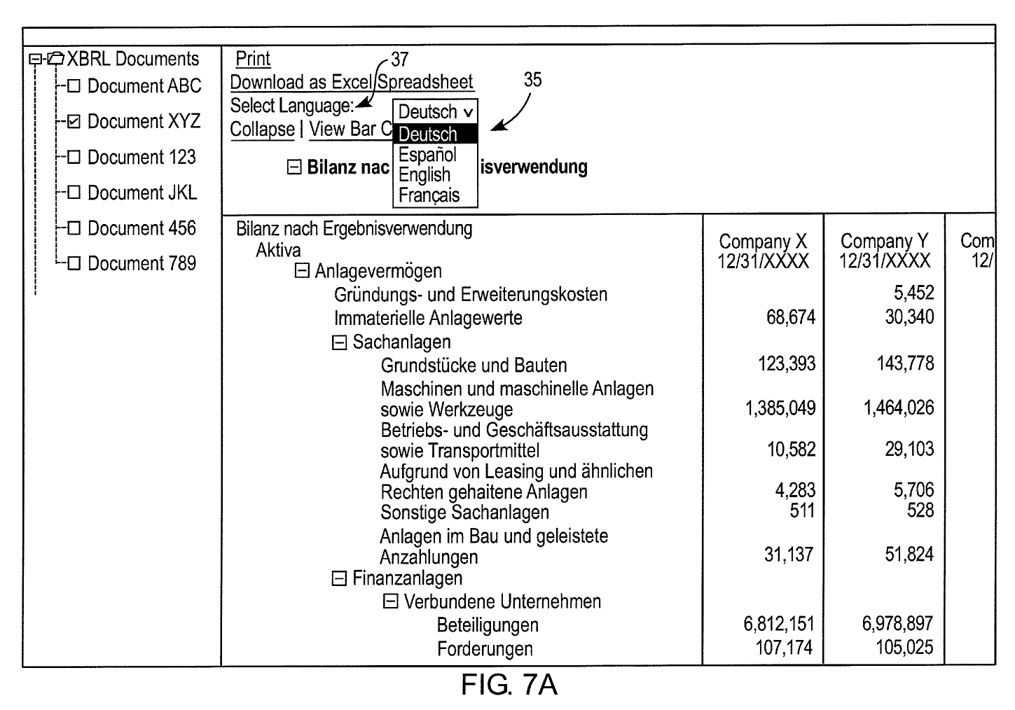

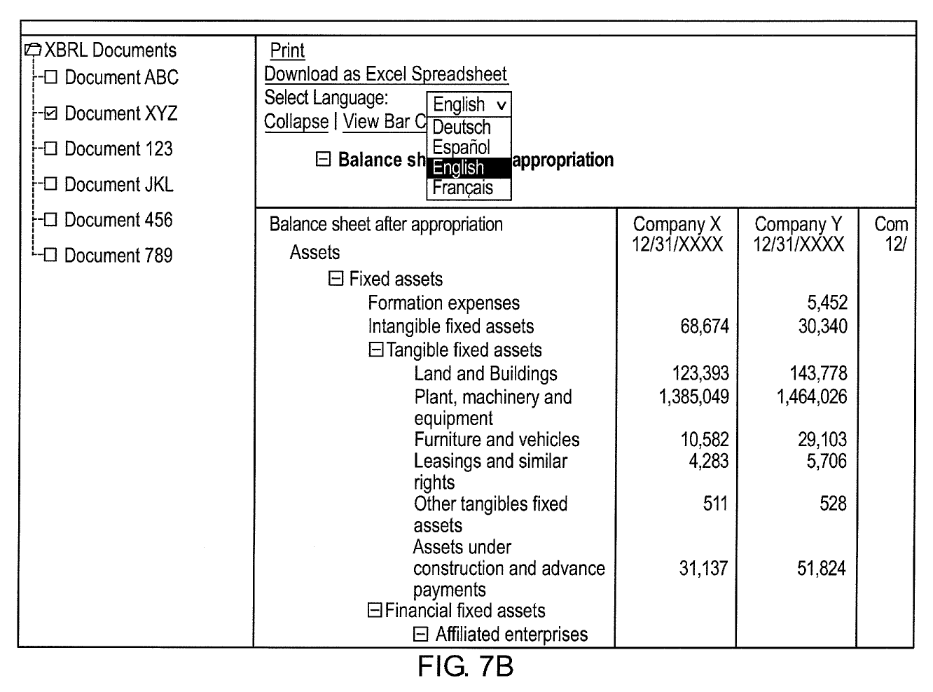

To accommodate this situation, a further feature of the invention dynamically assesses the languages associated with documents that are responsive to a request, and provides the user with an interface to select a desired one of the available languages. The interface can be in the form of a drop-down menu. An example of such a drop-down menu is shown in FIG. 7A, at 35. In this example, the data is presented with labels in the German language.

The dynamic processor provides the user with the ability to change the display language. The browser window is displayed with an interlace element 37 labeled “Select Language”. When the user clicks this element, the drop-down menu 35 appears. In the illustrated example, this menu contains four items, corresponding to the languages German, Spanish, English and French, in their respective native forms. This menu is dynamically generated and rendered by the dynamic processor. To do so, the dynamic processor examines the label linkbase to determine the available languages in the taxonomy, and displays each identified language as an item in the menu.

In the example of FIG. 7A, the menu item “Deutsch” is highlighted, corresponding to the display of the labels in the German language. FIG. 7B illustrates the effect when the user selects the “English” item from the menu. As can be seen, all of the data remains the same, but the labels associated with that data now appear in the English language. The dynamic processor achieves this result by retrieving the English-language version of the labels from the label linkbase. The change of the language can be carried out on a display-by-display basis, e.g. the summary screen may be displayed in one language, but the more detailed data for the same set of data can be displayed in another language.

The order in which the languages appear in the menu can be fixed. In accordance with another feature of the invention, the order can be varied in accordance with user preferences. For instance, the first time data responsive to a request is retrieved, it can be presented in the preferred language of the browser. This preferred language may be one of which is selected by the user when the browser is first installed.

Thereafter, the order of the languages in the menu can be revised in accordance with the selections made by the user. For instance, the most recent selection can appear at the top of the menu, followed by the next most recent selection, and so on. In the example of FIGS. 7A and 7B, the preferred language for the browser might be English, as indicated by the textual items in the browser window that are not related to the XBRL data. However, the selection for German appears at the top of the menu, since this was the most recent choice made by the user. Each time a user selects a new language, that selection can be brought to the top of the list. The dynamic processor can store the order of the selections, e.g. in the cache 33, and use that stored information to determine the order of appearance of the languages in the drop-down menu.

Not every label may be available in all of the indicated languages. For instance, in the example given in FIG. 6, the label “Assets” has four associated languages, but the linkbase for another label may only contain two languages, e.g. English and French. In this case, when displaying the labels, the dynamic processor steps through the languages in the order in which they are listed in the menu. For the “Assets” label, the German version is selected for display. In the case of the other label, German and Spanish versions are not available, so the English label is chosen, since it is the highest ranked language of those that are contained in the linkbase for that label.

In the examples depicted in FIGS. 7A and 7B, only the labels for the XBRL data are displayed in the selected language, and the remaining text in the browser window, e.g. commands, appear in the selected language of the browser. In an alternative implementation, the selection of a language can be applied to all text appearing in the browser window, to the extent supported by the language capabilities of the browser itself, rather than just the content retrieved from the XBRL documents.

The dynamic processor can be implemented within different software environments. In one implementation, the dynamic processor can reside as a stand alone desktop application, which communicates with one or more repositories of XBRL documents that are accessible via a desktop computer, for example through a network. In another implementation, the dynamic processor can be implemented as a client-server program. For instance, the components illustrated in FIG. 2 might reside in a server that is associated with the information repository, and the API can communicate with a client executing on a computer at a user's site, via HTML. As a third implementation, the data processor might be a web-based application executing on a server that a user accesses through a suitable browser. In each case, the software components that constitute the API and the dynamic processor are encoded on a computer-readable medium that is accessed by the supporting server and/or desktop computer.

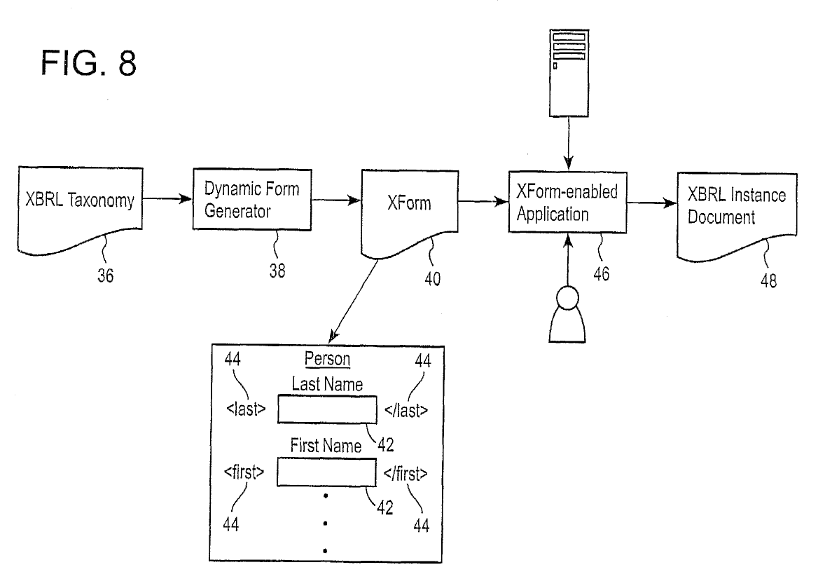

In addition to the processing of XBRL documents to retrieve data that is responsive to a request, the technology that underlies the invention can also be employed to generate forms that can be used to create XBRL documents. An example of an architecture for a dynamic form generator is illustrated in FIG. 8.

A form is generated on the basis of a particular taxonomy that is designated by the user. In generating a form, no assumptions are made about the structure of the taxonomy, other than the fact that it conforms to an XML-based specification, e.g. XBRL. Once the user has designated a particular taxonomy 36, and a name for the form, a dynamic form generator 38 within the dynamic processor examines the schema in the taxonomy, using suitable algorithms, to obtain labels that are relevant to the form to be generated. The form 40 is generated with data entry fields 42 that correspond to each label that was obtained from the taxonomy. In addition, the form is provided with XML tags 44 that are associated with each input Field, as described by the taxonomy 36.

Once the form is generated, it is resident as a live form, e.g. an XForm, on a network, such as the Internet. This form can then be accessed by a form-enabled application 46, via which a user can enter input data into each field 42, e.g. financial and business data in the case of an XBRL form. The completed form can then be submitted as a new XML instance document 48, and stored at a location designated by the user.

Thus it can be seen that the present invention provides dynamic evaluation of XML documents in response to a request, notwithstanding the diverse amount of metadata that can result with an extensible language. This is accomplished by analyzing the metadata to learn about the structure and semantics that are employed for any given set of XML documents. As a result, the need to pre-parse documents to derive data from them is avoided. Furthermore, forms for creating XML documents can be automatically generated without requiring manual input to designate fields or tags, or to publish the forms.

It will be appreciated by those of ordinary skill in the art that the invention described herein can be embodied in other specific forms without departing from the spirit or essential characteristics thereof. The disclosed implementations are considered in all respects to be illustrative, and not restrictive. The scope of the invention as indicated by the appended claims, rather than the foregoing description, and all changes that come within the meaning and range of equivalents thereof are intended to be embraced therein.

What is claimed is:

1. An system for dynamically retrieving data from a plurality of stored XML-compliant documents in which the data is in a tagged format and has associated metadata, comprising:
a processor that includes:
a first component that, in response to a request for information, analyzes metadata stored in XML documents to identify one or more languages associated with data in the documents; and
a second component that retrieves data from the stored documents in accordance with the request, based upon the metadata analyzed by first component; and
an interface that receives the data that was retrieved from the documents and presents the retrieved data in one of the languages associated with the retrieved data, based upon a user preference.

2. The system of claim 1 wherein said data is XBRL-formatted data, and said metadata includes XBRL Taxonomies.

3. The system of claim 1, wherein said interface dynamically generates a menu containing each of the languages identified by the first component in the analyzed data, and displays said menu in response to a user command.

4. The system of claim 3, wherein said interface changes the order in which the identified languages appear in said menu, based upon selections made from said menu by a user.

5. The system of claim 4, wherein the languages are displayed in said menu in order of most-recently selected to least-recently selected.

6. The system of claim 1, wherein said processor and interface are implemented in a stand-alone computer program.

7. The system of claim 1, wherein said processor is implemented as a component of a client-server program.

8. The system of claim 1, wherein said processor and interface are implemented in a network accessible application.

9. The system of claim 2, wherein the XBRL Taxonomies contain dimensions, and said user interface provides the user with the ability to select individual segments of a dimension for presentation.

10. The system of claim 1, wherein said user interface presents the retrieved data in either tabular or graphical form, in dependence upon a user selection.

11. A method for dynamically retrieving data from a plurality of stored XML-compliant documents in which the data is in a tagged format and has associated metadata, comprising the Following steps:
in response to a request for information, analyzing metadata stored in XML documents to identify one or more languages associated with data in the documents;
retrieving data from the stored documents in accordance with the request, based upon the metadata analyzed in said analyzing step; and
presenting the retrieved data in one of the languages associated with the retrieved data, based upon a user preference.

12. The method of claim 11 wherein said data is XBRL-formatted data, and said metadata includes XBRL Taxonomies.

13. The method of claim 11, further including the step of generating a menu containing each of the languages identified during the analyzing step, and displaying said menu in response to a user command.

14. The method of claim 13, further including the step of changing the order in which the identified languages appear in said menu, based upon selections made from said menu by a user.

15. The method of claim 14, wherein the languages are displayed in said menu in order of most-recently selected to least-recently selected.

16. The method of claim 12, wherein the XBRL Taxonomies contain dimensions, and further including the step of providing the user with the ability to select individual segments of a dimension for presentation.

17. The method of claim 11, further including the step of presenting the retrieved data in either tabular or graphical form, in dependence upon a user selection.

18. A computer-readable medium containing a program that causes a computer to execute the following operations:
in response to a request for information, analyzing metadata stored in XML, documents to identify one or more languages associated with data in the documents;
retrieving data from the stored documents in accordance with the request, based upon the metadata analyzed in said analyzing step; and
presenting the retrieved data in one of the languages associated with the retrieved data, based upon a user preference.

19. The computer-readable medium of claim 18 wherein said data is XBRL-formatted data, and said metadata includes XBRL Taxonomies.

20. The computer-readable medium of claim 18, wherein said program causes the computer to execute the operation of generating a menu containing each of the languages identified during the analyzing step, and displaying said menu in response to a user command.

21. The computer-readable medium of claim 20, wherein said program causes the computer to execute the operation of changing the order in which the identified languages appear in said menu, based upon selections made from said menu by a user.

22. The computer-readable medium of claim 21, wherein the languages are displayed in said menu in order of most-recently selected to least-recently selected.
